(19) United States
(12) Patent Application Publication
(10) Pub. No.: US 2015/0047945 A1
(43) Pub. Date: Feb. 19, 2015

(54) SYSTEM AND METHOD FOR COMBINED OPTICAL AND ULTRA SONIC DETECTION OF BANK NOTES

(71) Applicant: Toshiba International Corporation, Houston, TX (US)

(72) Inventor: Sohail Kayani, Irving, TX (US)

(21) Appl. No.: 13/967,944

(22) Filed: Aug. 15, 2013

(51) Int. Cl. G07D 7/12; G07D 7/08

(52) U.S. Cl. CPC G07D 7/124; G07D 7/08
USPC 194/207

(57) ABSTRACT

Methods and systems for automated detection of a transparent gap present between subsequent bank notes undergoing high-speed processing are disclosed. A system for distinguishing between bank notes in a bank note processing machine comprises a conveyance device for transporting a bank note along a transport path and a detector comprising an optical sensor and an ultrasonic sensor disposed at a desired location along the path. The optical sensor identifies a transparent region at the desired location and the ultrasonic sensor determines if the transparent region corresponds to a transparent gap.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### BACKGROUND OF THE INVENTION

1. Field of the Invention

The present invention relates to automated currency processing and, more specifically, to the automated detection of a transparent gap present between subsequent bank notes undergoing high-speed processing.

2. Description of Related Art including information disclosed under 37 CFR 1.97 and 1.98

In an effort to combat the counterfeiting of bank notes and other machine-processable security documents, substrate manufactures continue to develop and incorporate new security features into their product. For example, in some instances, one or more transparent stripes may be incorporated into a bank note. Such transparent stripes may be placed at a leading edge of the bank note, the middle portion of the bank note or any other portion of the bank note.

Current bank note processing machines feature numerous detectors and sensors to determine various attributes of a bank note being processed. A stack of bank notes may be provided as an input to a bank note processing machine. The bank note processing machine may then direct the bank notes one at a time through a transport path. As the bank notes travel through the transport path one at a time, they interact with the various detectors and sensors. The information gathered by the various detectors and sensors may then be compiled and/or analyzed to determine various characteristics of each bank note such as, for example, denomination, whether the bank note is counterfeit, how damaged the bank note is, etc.

When analyzing bank notes using a bank note processing machine, it is important to be able to distinguish between different bank notes that are travelling through the transport path. Specifically, it is desirable to determine when one bank note has left a particular detector and/or sensor and another bank note has entered. Typically, a bank note processing machine uses an optical sensor to distinguish between different bank notes. Specifically, one or more optical sensors may be placed at different positions along the transport path.

A typical bank note is opaque. Accordingly, as each bank note travels through the portion of the transport path where the optical sensors is located, the optical sensor detects an opaque material. There is a gap between the different bank notes traveling along the transport path. As a result, the optical sensor detects a transparent region once a bank note has passed by and before the next bank note has arrived at the optical sensor. This transparent region between subsequent bank notes is referred to herein as the “transparent gap”. Accordingly, the detection of a transparent gap is used by a typical bank note processing machine to distinguish between the different bank notes travelling along the transport path. However, with the introduction of bank notes having one or more transparent stripes, this typical method leads to a false distinction between the different notes. Specifically, what appears to be a transparent region indicating the end of one bank note and the beginning of another may in fact be a transparent stripe within the same bank note.

Accordingly, a need exists for a detector that can differentiate a transparent stripe on a bank note from a transparent gap between subsequent bank notes along the transport path.

### BRIEF SUMMARY OF THE INVENTION

The present invention relates to automated currency processing and, more specifically, to the automated detection of a transparent gap present between subsequent bank notes undergoing high-speed processing.

In one embodiment, the present disclosure is directed to a system for distinguishing between bank notes in a bank note processing machine comprising: a conveyance device for transporting a bank note along a transport path; a detector comprising an optical sensor and an ultrasonic sensor disposed at a desired location along the path; wherein the optical sensor identifies a transparent region at the desired location, and wherein the ultrasonic sensor determines if the transparent region corresponds to a transparent gap.

In accordance with another embodiment, the present disclosure is directed to a method for identifying a transparent gap between subsequent bank notes comprising: directing one or more bank notes along the transport path; positioning a detector having an optical sensor and an ultrasonic sensor along the transport path, wherein the detector monitors the transport path; identifying a transparent region using the optical sensor; and determining if the transparent region corresponds to at least one of a transparent stripe and a transparent gap using the ultrasonic sensor.

In certain embodiments, the present disclosure is directed to an information handling system having machine-readable instructions to: direct one or more bank notes along the transport path; position a detector having an optical sensor and an ultrasonic sensor along the transport path, wherein the detector monitors the transport path; identify a transparent region using the optical sensor; and determine if the transparent region corresponds to at least one of a transparent stripe and a transparent gap using the ultrasonic sensor.

These and other improvements will become apparent when the following detailed disclosure is read in light of the supplied drawings. This summary is not intended to limit the scope of the invention to any particular described embodiment or feature. It is merely intended to briefly describe some of the key features to allow a reader to quickly ascertain the subject matter of this disclosure. The scope of the invention is defined solely by the claims when read in light of the detailed disclosure.

### BRIEF DESCRIPTION OF THE SEVERAL VIEWS OF THE DRAWING(S)

The present invention will be more fully understood by reference to the following detailed description of the preferred embodiments of the present invention when read in conjunction with the accompanying drawings, in which like reference numbers refer to like parts throughout the views, wherein:

FIG. 1A depicts a block diagram of a bank note processing machine in accordance with an illustrative embodiment of the present disclosure.

FIG. 1B depicts an illustrative bank note having transparent gaps.

FIGS. 2A-2C illustrate interaction of a detector with a bank note passing through a transport path; and

FIG. 3 depicts method steps for operation of a detector in accordance with an illustrative embodiment of the present disclosure.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

### DETAILED DESCRIPTION OF THE INVENTION

Typical currency processing machines comprise a bank note feeder device, a transport device or belt providing a transport path along which bank notes travel past several detectors, and a final disposition component, which may typically include a pocket for collection of processed bank notes, a strapper for strapping the bank notes in bundles, and a means for depositing the bank notes into the pocket by pulling the bank notes from the bank note processing path or transport device. As the bank note is processed, detectors along the transport path scan the bank note for various attributes. It is important to distinguish between the different bank notes passing along the transport path so that the characteristics of one bank note are not falsely attributed to another bank note.

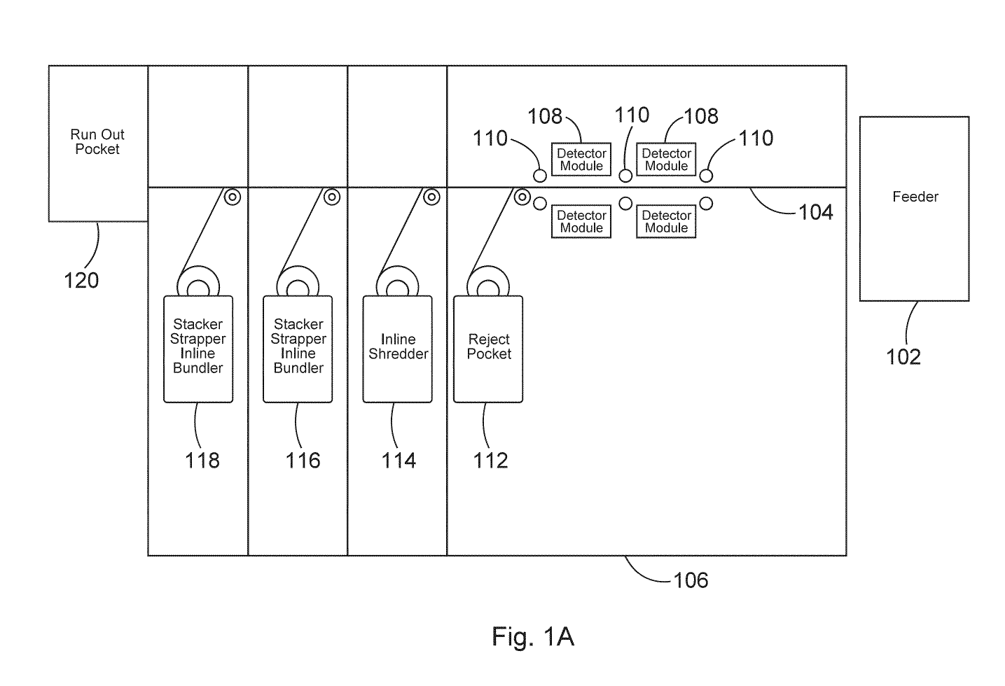

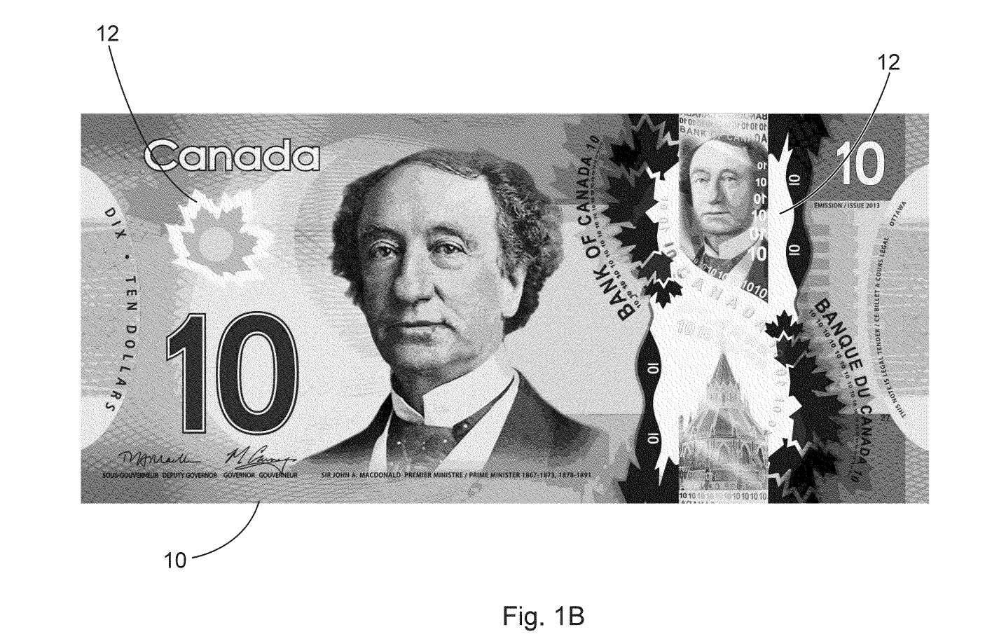

FIG. 1A depicts a block diagram of a bank note processing machine according to an illustrative embodiment of the present disclosure, highlighting the location of the detectors with respect to the processing stream. In certain illustrative embodiments, a bank note is first stripped from a stack of notes in a feeder (102) and sent along a transport path (104) through a scanner module (106). Within the scanner module (106), one or more detector modules (108) may be disposed is an area centered on the transport path (104). As shown in FIG. 1A, the detector modules (108) are placed such that a bank note passing along the transport path (104) passes through the detector modules.

The detector modules (108) may be any suitable detector module known to those of ordinary skill in the art, having the benefit of the present disclosure. For instance, in certain implementations, the detector modules (108) may be used to detect the denomination of a bank note, whether the bank note is counterfeit, and/or perforations or other damage to the bank notes.

In accordance with an illustrative embodiment of the present disclosure, one or more detectors (110) may be disposed at different locations along the transport path (104). A detector (110) may be used to identify gaps between different bank notes that are transported along the transport path (104). Manner of operation of such detectors (110) is discussed in further detail below.

A detector (110) may be placed at any location along the transport path (104) where it is desirable to distinguish between different bank notes. For instance, in certain embodiments, a detector (110) may be placed before and/or after one or more of the detector modules (108). As a result, the detectors (110) may be used to determine when one bank note has exited a detector module (108) and another bank note has entered. This information may then be used to ensure that characteristics identified by each detector module (108) for a bank note passing therethrough are attributed to the correct bank note.

After passing through the detector modules (108) the information gathered by the detector modules (108) may be used to sort the bank notes. Specifically, certain bank notes (e.g., counterfeit notes) may go to a reject pocket (112). Further, some of the bank notes may be directed to an inline shredder (114) and destroyed. Other bank notes may be directed to a first stacker strapper inline bundler (116) and a second stacker strapper inline bundler (118). Finally, some of the bank notes may be directed to a run out pocket (120) positioned at the end of the transport path (104).

In certain implementations, a central processor (not shown) can be used to control and/or harmonize the operation of the various components of a bank note processing machine such as the one shown in FIG. 1A. The central processor may be an information handling system that is communicatively coupled to the bank note processing machine through a wired or wireless communication means. Operation of such communication means is well known to those of ordinary skill in the art and will therefore, not be discussed in detail herein.

An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

The central processor can be controlled by one or multiple computer processing devices, which control the timing of the system as well as activation of the detectors and control of bank note disposition. One of ordinary skill will appreciate that the central processor may be either a single processing unit or it may consist of multiple processors. Regardless of the configuration, the central processor performs the same function. Computer memory is also present, providing storage capacity for the computer code which controls the central processor's actions. The central processor is capable of running the stored program steps from the accessible memory. The processing device may be a dedicated general purpose computer, an embedded RISC or CISC computer processor, a DSP, or the like.

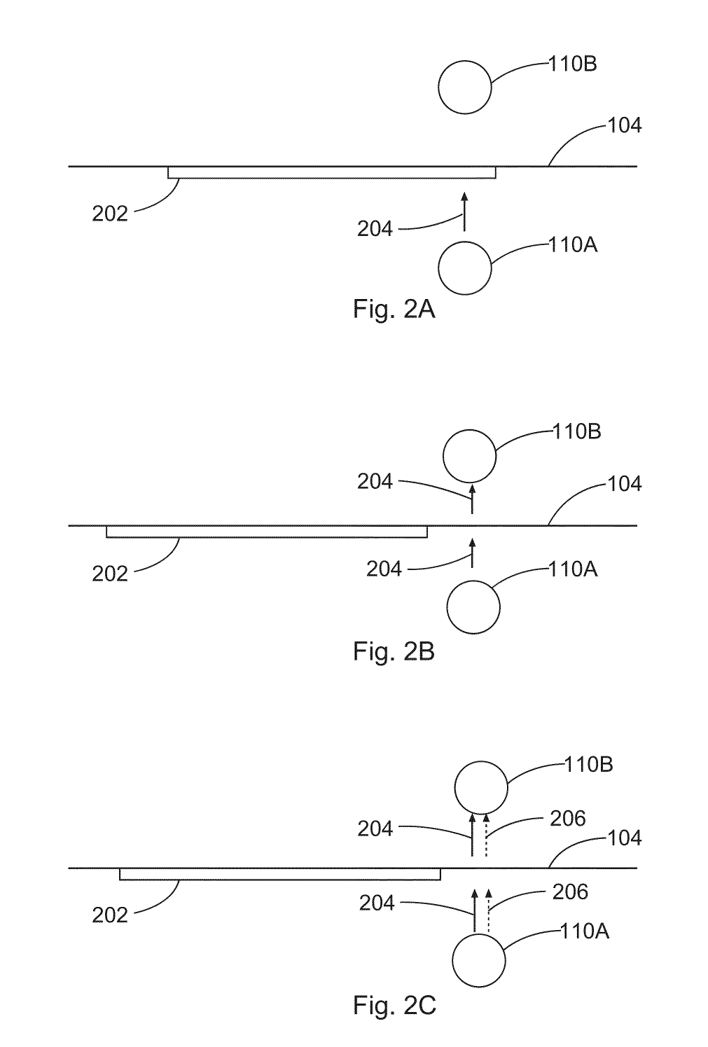

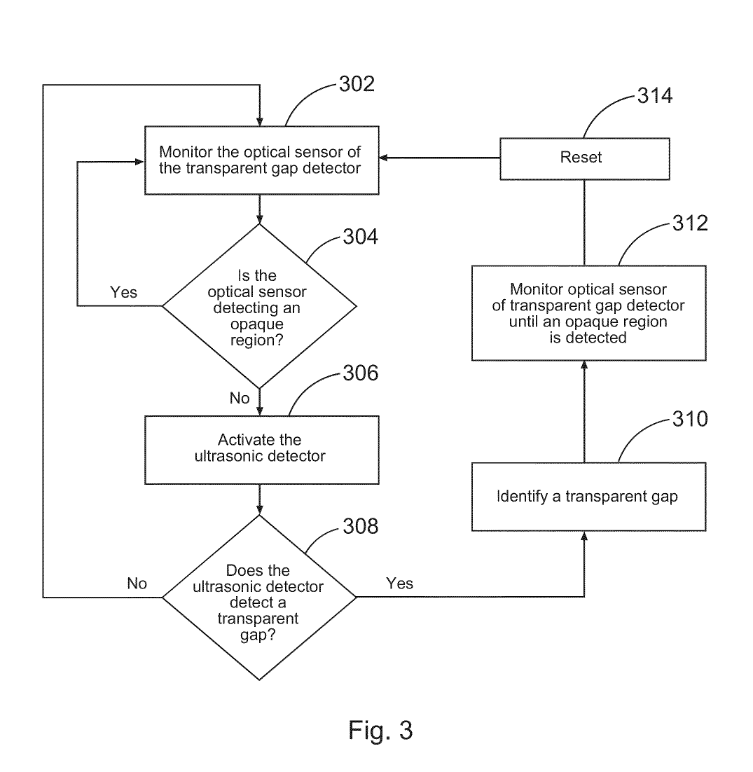

The details of operation of a detector (110) in accordance with illustrative embodiments of the present disclosure will now be discussed in conjunction with FIGS. 2A-C and the flow chart of FIG. 3.

A detector (110) in accordance with illustrative embodiments of the present disclosure may be comprised of an optical sensor and an ultrasonic sensor. In certain embodiments, the optical sensor and the ultrasonic sensor of the detector (110) may be distinct components. In contrast, in certain embodiments, an integrated sensor which is operable as an optical sensor and as an ultrasonic sensor may be used as the detector (110).

FIG. 1B depicts an illustrative bank note 10 that may be processed using the methods and systems disclosed herein. As shown in the figure, the bank note 10 may include one or more transparent gaps 12. The bank note of FIG. 1B is shown for illustrative purposes. Accordingly, the transparent gaps 12 may be oriented as desired for a particular note without departing from the scope of the present disclosure.

FIG. 2A depicts a bank note (202) passing along a transport path (104) having a detector (110). The detector (110) includes a transmitter (110A) and a receiver (110B) disposed along the transparent path (104) such that any bank note travelling along the transport path (104) would pass through between the transmitter (110A) and the receiver (110B). In the illustrative embodiment of FIG. 1, the transmitter (110A) and the receiver (110B) are disposed on opposing sides of the transport path (104). The specific orientation of the transmitter (110A) and the receiver (110B) is shown for illustrative purposes only. Accordingly, the transmitter (110A) and receiver (110B) may be oriented differently without departing from the scope of the present disclosure. As shown in FIG. 2A, while the bank note is passing along the portion of the transport path (104) corresponding to the detector (110), the optical signal (204) transmitted by the transmitter (110A) is impeded by the bank note. As a result, the optical signal received by the receiver (110B) will be below a pre-set threshold value indicating that the optical path between the transmitter (110A) and the receiver (110B) is blocked. Accordingly, the optical sensor of the detector (110) detects an opaque region corresponding to the bank note (202).

As shown in FIG. 2B, once the bank note (202) passes by the detector (110), the optical signal (204) transmitted by the transmitter (110A) is no longer impeded by the bank note (202) and will be received by the receiver (110B). Accordingly, the optical sensor of the detector (110) will detect a transparent region. Once a transparent region is detected by the optical sensor of the detector (110), the ultrasonic detector of the detector (110) is activated and transmits an ultrasonic signal (206). If the transparent region identified by the optical signal (204) corresponds to a transparent stripe in the bank note (202), the ultrasonic signal (206) is impeded by the transparent region of the bank note (202). Accordingly, the ultrasonic signal (206) received by the receiver (110B) will be below a pre-set threshold value indicating that the path between the transmitted (110A) and the receiver (110B) is blocked by a bank note. In contrast, if as shown in FIG. 2C, the transparent region corresponds to a transparent gap between subsequent bank notes, the ultrasonic signal (206) will not be impeded by the bank note and the signal received at the receiver (110B) will be above a pre-set threshold value indicating the existence of a transparent gap.

As would be appreciated by those of ordinary skill in the art, having the benefit of the present disclosure, any suitable optical sensor or ultrasonic sensor may be used in the detector (110) without departing from the scope of the present disclosure.

Turning now to FIG. 3, method steps for analyzing bank notes directed through a bank note processing machine in accordance with an illustrative embodiment of the present disclosure are depicted. As shown in FIG. 3, first, at step 302, the optical sensor of the detector (110) is monitored. In certain embodiments, a central processor as discussed above may monitor and manage the operation of the detector (110). For instance, the central processor may manage transmission of optical and/or ultrasonic signals by the transmitter (110A) and monitor the signal received by corresponding receivers.

Next, at step 304 it is determined whether the optical sensor is detecting an opaque region or a transparent region. In certain implementations, an opaque region is detected if the optical signal received by the receiver (110B) is below a pre-set threshold value and a transparent gap is detected if the optical signal received by the receiver (110B) is above a pre-set threshold value. Detection of an opaque region is indicative of the fact that a bank note is passing along the transport path through the region corresponding to the detector (110). Accordingly, the process returns to step 302 to monitor the optical sensor. This cycle continues until it is determined at step 304 that the optical sensor is detecting a transparent region (i.e., it is not detecting an opaque region).

If a transparent region is detected at step 304, the process continues to step 306 and the ultrasonic detector of the detector (110) is activated. At step 308 it is determined whether the ultrasonic signal received by the receiver (110B) is above a pre-set threshold value. Specifically, if the transparent region detected by the optical sensor of the detector (110) corresponds to a transparent stripe and not a transparent gap, the transparent stripe impedes the transmission of ultrasonic signals generated by the transmitter (110A). As a result, the ultrasonic signal received by the receiver (110B) will be below a pre-set threshold value. It is thus concluded that the transparent region corresponds to a transparent stripe in a bank note and the process is returned to step 302 to continue to monitor for the next occurrence of a transparent region.

In contrast, if the ultrasonic signal is transmitted through a transparent gap, it is not impeded. As a result, the ultrasonic signal received by the receiver (110B) will be above a pre-set threshold value indicating that the transparent region is in fact a transparent gap. Accordingly, if the ultrasonic signal received at the receiver (110B) is above the pre-set threshold value, the process continues to step 310 and it is concluded that the transparent region is a transparent gap between subsequent bank notes. Next, at step 312, the optical sensor of the detector (110) continues to monitor the transport path (104) until an opaque region is detected indicating arrival of another bank note. The process is then reset at step 314 and returned to step 302. The above steps are then repeated to determine when the new bank note has passed through the detector (110).

As would be appreciated by those of ordinary skill in the art, having the benefit of the present disclosure, while the present embodiment depicts use of a single optical detection device and a single ultrasonic detection device, other embodiments may use multiple instances of each. Further, as would be appreciated by those of ordinary skill in the art having the benefit of the present disclosure, in certain illustrative embodiments the central processor may contain machine-readable instructions that enable it to perform the methods disclosed herein.

Further, as would be appreciated by those of ordinary skill in the art, having the benefit of the present disclosure, the methods and systems disclosed herein may be used in conjunction with any type of bank notes. Accordingly, the term “bank note” as used herein is defined broadly to include the various types of bank notes known to those of ordinary skill in the art, such as, for example, bills made from polymers, cotton paper, regular paper, textiles or any other desirable fibers.

The invention may be embodied in other specific forms without departing from the spirit or essential characteristics thereof. The present embodiments are therefore to be considered in all respects as illustrative and not restrictive. Accordingly, the scope of the invention is established by the appended claims rather than by the foregoing description. All changes which come within the meaning and range of equivalency of the claims are therefore intended to be embraced therein. Further, the recitation of method steps does not denote a particular sequence for execution of the steps. Such method steps may therefore be performed in a sequence other than that recited unless the particular claim expressly states otherwise.

I claim:

1. A system for distinguishing between bank notes in a bank note processing machine comprising:
a conveyance device for transporting a bank note along a transport path;
a detector comprising an optical sensor and an ultrasonic sensor disposed at a desired location along the path;
wherein the optical sensor identifies a transparent region at the desired location, and
wherein the ultrasonic sensor determines if the transparent region corresponds to a transparent gap.

2. The system of claim 1, wherein the optical sensor and the ultrasonic sensor are integrated.

3. The system of claim 1, wherein at least one of the optical sensor and the ultrasonic sensor comprises a transmitter and a receiver.

4. The system of claim 4, wherein the optical sensor identifies a transparent region if an optical signal received at the receiver of the optical sensor is above a threshold value.

5. The system of claim 4, wherein the ultrasonic sensor determines that the transparent region corresponds to a transparent gap if an ultrasonic signal received at the receiver of the ultrasonic sensor is above a threshold value.

6. A method for identifying a transparent gap between subsequent bank notes comprising:
directing one or more bank notes along the transport path;
positioning a detector having an optical sensor and an ultrasonic sensor along the transport path, wherein the detector monitors the transport path;
identifying a transparent region using the optical sensor; and
determining if the transparent region corresponds to at least one of a transparent stripe and a transparent gap using the ultrasonic sensor.

7. The method of claim 6, wherein the optical sensor and the ultrasonic sensor are integrated.

8. The method of claim 6, wherein at least one of the optical sensor and the ultrasonic sensor comprises a transmitter and a receiver disposed on opposing sides of the transport path.

9. The method of claim 8, further comprising transmitting an optical signal from the transmitter of the optical sensor and monitoring a signal received at the receiver of the optical sensor.

10. The method of claim 9, further comprising identifying a transparent region if the signal received at the receiver of the optical sensor is above a threshold value.

11. The method of claim 10, further comprising transmitting an ultrasonic signal from the transmitter of the ultrasonic sensor and monitoring a signal received at the receiver of the ultrasonic sensor.

12. The method of claim 11, further comprising identifying a transparent gap if the signal received at the receiver of the ultrasonic sensor is above a threshold value.

13. The method of claim 11, further comprising identifying a transparent stripe if the signal received at the receiver of the ultrasonic sensor is below a threshold value.

14. An information handling system having machine-readable instructions to:
direct one or more bank notes along the transport path;
position a detector having an optical sensor and an ultrasonic sensor along the transport path, wherein the detector monitors the transport path;
identify a transparent region using the optical sensor; and
determine if the transparent region corresponds to at least one of a transparent stripe and a transparent gap using the ultrasonic sensor.

15. The information handling system of claim 14, wherein the optical sensor and the ultrasonic sensor are integrated.

16. The information handling system of claim 14, wherein at least one of the optical sensor and the ultrasonic sensor comprises a transmitter and a receiver disposed on opposing sides of the transport path.

17. The information handling system of claim 16, further comprising machine-readable instructions to transmit an optical signal from transmitter of the optical sensor and monitor a signal received at the receiver of the optical sensor.

18. The information handling system of claim 17, further comprising machine-readable instructions to identify a transparent region if the signal received at the receiver of the optical sensor is above a threshold value.

19. The information handling system of claim 18, further comprising transmitting an ultrasonic signal from the transmitter of the ultrasonic sensor and monitoring a signal received at the receiver of the ultrasonic sensor.

20. The information handling system of claim 19, further comprising identifying a transparent gap if the signal received at the receiver of the ultrasonic sensor is above a threshold value.
